(19) United States
(12) Patent Application Publication
(10) Pub. No.: US 2018/0325008 A1
(43) Pub. Date: Nov. 15, 2018

(54) A SIEVE AND A DEVICE FOR PICKING STONES FROM SOIL

(71) Applicant: CNH Industrial Danmark A/S, Hvidovre (DK)

(72) Inventors: Esko Martikainen, Mynämäki (FI); Adam Michalak, Kutno (PL)

(21) Appl. No.: 15/773,485

(22) PCT Filed: Nov. 4, 2016
(86) PCT No.: PCT/DK2016/050355

§ 371 Date: May 3, 2018

(30) Foreign Application Priority Data
Nov. 7, 2015 (DK) PA 2015 00699

(51) Int. Cl. A01B 43/00

(52) U.S. Cl. CPC A01B 43/00

(57) ABSTRACT

The invention relates to a sieve 100 for stone picking stones from soil, said sieve in the orientation intended for use comprising: a number of bars 2,2′,2″,2′″, wherein each bar is extending in a longitudinal direction between a lower end 4 configured to be at least partly submerged in soil, and an upper end 6; wherein each said bar comprises a leading surface 8 extending a distance L from a first edge 10 to a second edge 12 of said leading surface of said bar; wherein each said bar comprises a trailing surface 14; wherein in respect of two specific adjacent bars 2,2′,2″,2′″, preferably in respect of any two adjacent bars, the geometry of the bars and the sieve is configured in such a way that the smallest distance D between said two adjacent bars is being present at the leading surface of said two adjacent bars. Also provided is a stone picking device comprising a sieve according to the invention.

### FIELD OF THE INVENTION

The present invention relates to the field of agriculture. More specifically, the present invention relates in a first aspect to a sieve for picking stones from soil.

In a second aspect the present invention relates to a stone picking device for picking and colleting stones from soil.

In a third aspect the present invention relates to a use of a sieve according to the first aspect of the present invention or of a device according to the second aspect of the present invention for stone picking stones from soil

In a fourth aspect the present invention relates to method for stone picking stones from soil.

### BACKGROUND OF THE INVENTION

In the field of agriculture it has for centuries been acknowledged that in order to obtain a good yield of crops in terms of quantity and quality it will be necessary at regular intervals to provide a conditioning of the soil in which the crops are to be grown.

Such conditioning may relate to ploughing, cultivation, harrowing etc. The conditioning serves the purpose of aerating the soil, destroying the rooting of weed and to burry residues of last year's crops.

Conditionings like ploughing, cultivation and harrowing are typically performed by towing an agricultural tool or implement behind a tractor.

In case the soil contains large stones of rocks the process of cultivating the soil will inevitably result in damaging the soil working tools of such cultivators.

Furthermore, the presence of stones and rocks in agricultural soil will in itself be detrimental in respect of efficiency of crop yield in that the individual stones take up space in the soil which otherwise could be utilized by growing crops.

Stones in soil likewise pose a problem in the field of gardening, horticulture, road construction, beach cleaning and other material handling.

In order to reduce the amount of stones in soil a range of different tools have been developed, all serving the purpose of removing stones from the soil.

Some of these tools comprise a sieve which comprises a number of parallel bars. The sieve is intended for moving through the soil, e.g. by being towed by a tractor. The distance between adjacent bars determines the coarseness of the sieve and hence determines the threshold between stone sizes to be picked or collected and sizes of material to be left in the soil.

However, these tools all suffer from drawbacks relating to a tendency of the sieve to let stones clog the sieve because stones, due to an inefficient design of these sieves, are prone to get stuck in the gap between adjacent bars of the sieve.

One such tool is disclosed in US 540 148. US 540 148 discloses an apparatus in the form of a combined stone gatherer and potato digger. This apparatus comprises a number of bars arranged in parallel on two crossbars in a frame. Each bar is having an L-shaped cross-section. In the apparatus of US 540 148 the bars are not grouped in pairs by providing a connection of the lower ends of each of two adjacent bars. Thereby, stones are prone to get stuck in the gap between adjacent bars at the lower ends thereof.

Accordingly, there exists a need for improving stone picking of stones from soil avoiding the disadvantages of the prior art.

It is an objective of the present invention to provide a solution to the above stated problem in order to reduce or even eliminate the disadvantages encountered by the prior art stone picking devices.

### BRIEF DESCRIPTION OF THE INVENTION

This objective is attained with the present invention in its first, second, third, and fourth aspect.

Accordingly, the present invention relates in a first aspect to a sieve for stone picking stones from soil, said sieve in the orientation intended for use comprising:

a number of bars, wherein each bar is extending in a longitudinal direction between a lower end configured to be at least partly submerged in soil, and an upper end;

wherein each said bar comprises a leading surface extending a distance from a first edge to a second edge of said leading surface of said bar;

wherein each said bar comprises a trailing surface;

wherein in respect of two specific adjacent bars, preferably in respect of any two adjacent bars, the geometry of the bars and the sieve is configured in such a way that the smallest distance between said two adjacent bars is being present at the leading surface of said two adjacent bars;

characterized in that one or more sets of two adjacent bars, preferably all sets of two adjacent bars, of the sieve are being grouped in pairs in such a way that the lower end of two adjacent bars are being connected to each other.

The present invention relates in a second aspect to a stone picking device for picking and colleting stones from soil;

wherein said stone picking device comprises a frame;

wherein said frame comprises a sieve according to any of the preceding claims;

wherein said frame comprises stone conveying means for removing stones from an area located at an upper end of said bars of said sieve.

In its third aspect the present invention relates to a use of a sieve according to the first aspect of the present invention or of a device according to the second aspect of the present invention for stone picking stones from soil.

In a fourth aspect, the present invention relates to a method for stone picking stones from soil, wherein said method comprises:

i) providing a sieve according to the first aspect of the present invention;

ii) arranging said sieve in such a way that its lower end is at least partly being submerged into the surface of soil;

iii) moving the sieve through the soil in a direction defined by the leading surface of the bars of the sieve;

iv) collecting and removing stones having a size preventing them from passing between two adjacent bars, while allowing soil material having smaller sizes to pass between two adjacent bars.

The present invention in its various aspects provides for enhanced stone picking efficiency.

This result is brought about by virtue of the special design of the individual bars of the sieve which to a large extent avoids the clogging of stones between individual bars of the sieve.

### BRIEF DESCRIPTION OF THE FIGURES

FIG. 1 is a perspective view of a sieve according to the first aspect of the present invention.

FIG. 2 is a side view illustrating the working mode of the sieve according to the first aspect of the present invention.

FIG. 3 is a top view illustrating one embodiment of a sieve according to the first aspect of the present invention.

FIG. 4 is a top view illustrating another embodiment of a sieve according to the first aspect of the present invention.

FIG. 5a shows a cross-section of the bars of one embodiment of a sieve according to the present invention.

FIG. 5b shows a cross-section of the bars of another embodiment of a sieve according to the present invention.

FIG. 5c shows a cross-section of the bars of yet another embodiment of a sieve according to the present invention.

FIG. 6 is a schematic illustration showing a top view of a stone picking device according to the second aspect of the present invention.

### DETAILED DESCRIPTION OF THE INVENTION

### The First Aspect of the Present Invention

In a first aspect, the present invention relates to a sieve for stone picking stones from soil, said sieve in the orientation intended for use comprising:

a number of bars, wherein each bar is extending in a longitudinal direction between a lower end configured to be at least partly submerged in soil, and an upper end;

wherein each said bar comprises a leading surface extending a distance from a first edge to a second edge of said leading surface of said bar;

wherein each said bar comprises a trailing surface;

wherein in respect of two specific adjacent bars, preferably in respect of any two adjacent bars, the geometry of the bars and the sieve is configured in such a way that the smallest distance between said two adjacent bars is being present at the leading surface of said two adjacent bars;

characterized in that one or more sets of two adjacent bars, preferably all sets of two adjacent bars, of the sieve are being grouped in pairs in such a way that the lower end of two adjacent bars are being connected to each other.

The special design of the geometry of the bars provides for avoiding, to a great extent, the clogging of stones in the sieve.

In the present description and in the appended claims it should be understood that the term “the geometry of the bars and the sieve is configured in such a way that the smallest distance between said two adjacent bars is being present at the leading surface of said two adjacent bars” preferably is to be interpreted in such a way that when comparing the distance between two adjacent bars, at the leading surface thereof and at a trailing surface thereof, respectively, the measurement is performed at an equal longitudinal position of the two adjacent bars.

In one embodiment of the first aspect of the present invention one or more of said bars, preferably all of said bars, are exhibiting a concave curvature in the lengthwise direction along the leading surface of said bars.

In one embodiment of the first aspect of the present invention one or more of said bars, preferably all of the bars, are exhibiting a convex curvature in the lengthwise direction along the trailing surface of said bars.

Such curvatures will provide for improved flow of stones, being picked up, along the bars.

In one embodiment of the first aspect of the present invention the number of bars is 4-210 bars, such a 10-200 bars, for example 20-190 bars, such as 30-180 bars, for example 40-170 bars, such as 50-160 bars, for example 60-150 bars, such as 70-140 bars, such as 80-130 bars, e.g. 90-120 bars or 100-110 bars.

These numbers will provide for great efficiency because these numbers secure a significant working width.

In one embodiment of this embodiment said bars are being grouped in pairs in such a way that the lower ends of two adjacent bars are being connected to each other via an end part so as to form a U-shape end of said two adjacent bars.

Connecting the bars in pairs at a lower end thereof provides for enhanced strength of the sieve in a situation where the lower ends are being moved through soil.

In one embodiment of the first aspect of the present invention said bars are being reinforced by being connected to a bracket.

In one embodiment of this embodiment said bracket is mounted on a trailing surface of said bars.

Connecting the bars to a bracket provides for enhanced strength of the sieve.

In one embodiment of the first aspect of the present invention, the geometry of the bars and the sieve, in respect of two specific adjacent bars, preferably in respect of any two adjacent bars, is configured in such a way that the smallest distance between said two adjacent bars is only being present at the position of the leading surface of said two adjacent bars.

This ensures that stones will not be clogged in a trailing part of the sieve.

In one embodiment of the first aspect of the present invention said bars are being parallel arranged on said sieve.

In one embodiment of the first aspect of the present invention said bars are having a longest extension of 0.5-2.0 m, such as 0.6-1.9 m, for example 0.7-1.8 m, e.g. 0.8-1.7 m, for example 0.9-1.6 m, such as 1.0-1.5 m, for example 1.1-1.4 m or 1.2-1.3 m.

These embodiments have proven to provide for efficient stone trapping.

In one embodiment of the first aspect of the present invention the thickness of the bars, in a transverse direction relative to the intended direction of movement, is 10-65 mm, such as 15-60 mm, for example 20-55 mm, e.g. 25-50 mm, such as 30-45 mm or 35-40 mm.

These dimensions secure sufficient strength of the sieve.

In one embodiment of the first aspect of the present invention the mutual distance d between a bar and its adjacent bar, in respect of one or more of said bars, preferably in respect of all said bars, measured either at the leading surface or at the trailing surface, varies along the length of said bar.

In one embodiment of this embodiment the mutual distance d between a bar and its adjacent bar varies along the length of said bar so as to increase when going from a lower end of said bar to an upper end of said bar; or so as to decrease when going from a lower end of said bar to an upper end of said bar.

In one embodiment of the first aspect of the present invention and in respect of one or more of said bars, preferably in respect of all said bars, the cross section of said bar(s) is defining the shape of an isosceles trapezoid having side legs of equal length, wherein the longest base of the isosceles trapezoid is forming the leading surface of the bar and wherein the shortest base of the isosceles trapezoid is forming the trailing surface of the bar, thus extending between a first edge and a second edge of said trailing surface of said bar.

In one embodiment of the first aspect of the present invention, and in respect of one or more of said bars, preferably in respect of all said bars, the cross section of said bar(s) is defining the shape of a semicircle, wherein the diameter of the semicircle is forming the leading surface of the bar and wherein the curved perimeter of the semicircle is forming the trailing surface of the bar.

In one embodiment of the first aspect of the present invention and in respect of one or more of said bars, preferably in respect of all said bars, the cross section of said bar(s) is defining the shape of a triangle, wherein one edge of the triangle is forming the leading surface of the bar, and wherein part of two edges and one vertex of the triangle is forming the trailing surface of the bar.

These geometries of the cross sections provide for an efficient design in respect of avoiding clogging of stones.

In one embodiment of the first aspect of the present invention said sieve comprises adjustment means for adjustment of the mutual distances d between two specific adjacent bars, preferably between any two adjacent bars.

Such means for adjustment provides for an easy change of the threshold between size of stones to be picked up and size of stones to be left in the soil.

In one embodiment of the first aspect of the present invention and in respect of one or more of said bars, preferably in respect of all said bars, the smallest distance between one edge of the leading surface of a specific bar and the nearest edge of the leading surface of an adjacent bar is 2-65 cm, such as 5-60 cm, for example 10-55 cm, such as 15-50 cm, for example 20-45 cm, such as 25-40 cm or 30-35 cm.

This distance determines the threshold between size of stones to be picked up and size of stones to be left in the soil.

### The Second Aspect of the Present Invention

In a second aspect, the present invention relates to a stone picking device for picking and colleting stones from soil;

wherein said stone picking device comprises a frame;

wherein said frame comprises a sieve according to the first aspect of the present invention;

wherein said frame comprises stone conveying means for removing stones from an area located at an upper end 6 of said bars of said sieve.

The stone picking device according to the second aspect of the present invention provides for easy collection of stones being picked up by the sieve.

In one embodiment of the second aspect of the present invention said stone conveying means being a conveyor belt.

In one embodiment of the second aspect of the present invention the stone picking device further comprising depth adjustment means for adjusting the depth of submersion into soil of the lower end of said bars of said sieve.

This embodiment provides flexibility in the operation of the device.

In one embodiment of the second aspect of the present invention, the stone picking device further comprising a hopper for storing the stones, removed by the stone conveying means.

A hopper provides for easy disposal of the stones being collected from the soil.

In one embodiment of the second aspect of the present invention said frame comprises one or more wheels.

In one embodiment of the second aspect of the present invention said device is being a self-propelled device or wherein said device comprises coupling means for enabling coupling of the device to a towing tractor or the like.

These embodiments provide for powered towing of the device.

In one embodiment of the second aspect of the present invention said device further comprising soil loosening and/or stone lifting means arranged in front of the sieve, relative to the intended direction of movement thereof.

In one embodiment of this embodiment said soil loosening and/or stone lifting means comprises shears arranged on an axle and being configured to be able to rotate with the view to loosen soil and/or to lift from the soil, stones being present in the soil.

Such soil loosening and/or stone lifting means provides for better capture of stones by the sieve.

### The Third Aspect of the Present Invention

In a third aspect, the present invention relates to a use of a sieve according to the first aspect of the present invention or of a device according to the second aspect of the present invention for stone picking stones from soil.

### The Fourth Aspect of the Present Invention

In a fourth aspect, the present invention relates to method for stone picking stones from soil, wherein said method comprises:

i) providing a sieve according to the first aspect of the present invention;

ii) arranging said sieve in such a way that its lower end is at least partly being submerged into the surface of soil;

iii) moving the sieve through the soil in a direction defined by the leading surface of the bars of the sieve;

iv) collecting and removing stones 300 having a size preventing them from passing between two adjacent bars, while allowing soil material having smaller sizes to pass between two adjacent bars.

In one embodiment of the fourth aspect of the present invention the method is performed using a device according to the first aspect of the present invention.

In one embodiment of the fourth aspect of the present invention the speed of movement of the sieve is 1-14 km/h, such as 2-13 km/h, for example 3-12 km/h, for example 4-11 km/h, such as 5-10 km/h, for example 6-9 km/h or 7-8 km/h.

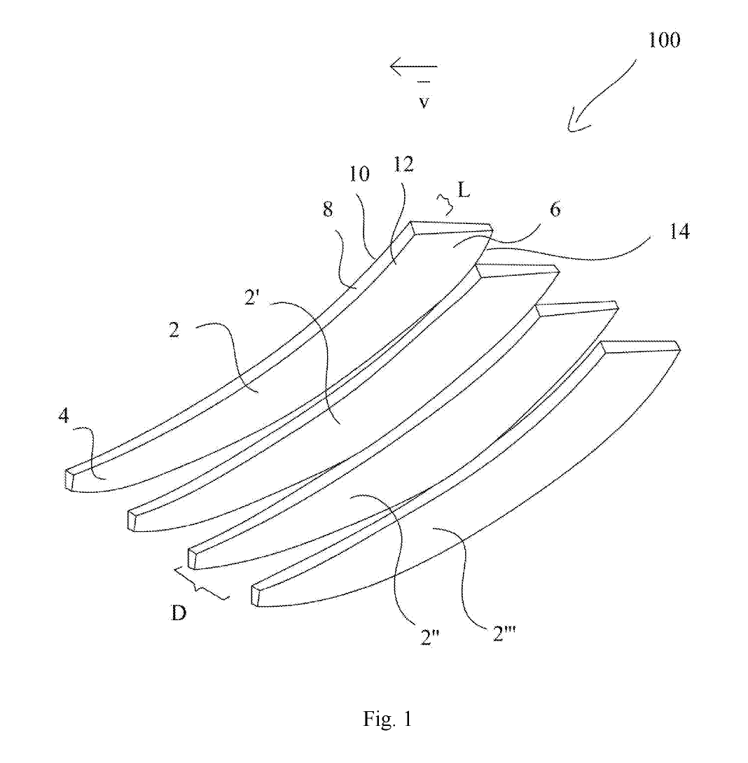

Referring now in details to the drawings for the purpose of illustrating preferred embodiments of the present invention, FIG. 1 illustrates a perspective view of a sieve according to a first aspect of the present invention. The sieve 100 is for stone picking stones from soil. The sieve comprises in the orientation intended for use four bars 2,2′,2″,2′″, wherein each bar is extending in a longitudinal direction between a lower end 4 configured to be at least partly submerged in soil, and an upper end 6.

Each of the bars comprises a leading surface 8 extending a distance L from a first edge 10 to a second edge 12 of the leading surface of the bar. Furthermore, each bar comprises a trailing surface 14.

The sieve 100 is characterized in that that in respect of any two specific adjacent bars 2,2′,2″,2″′, the geometry of the bars and the sieve is configured in such a way that the smallest distance between said two adjacent bars is being present at the leading surface of said two adjacent bars.

During the intended use, the lower part of the sieve 100, that is the lower part 4 of each bar is at least partly submerged into soil which is to be cleaned from stones and the sieve is moved through the soil in the direction defined by the leading surface 4 of the bars. This direction is in FIG. 1 indicated by the velocity vector v.

It can be seen in FIG. 1 that the cross section of each bar 2,2′,2″,2″′, is wedged and that the leading surface 4 is having a larger extension in a transverse direction, relative to the intended direction of movement of the sieve at the leading surface thereof, compared to the trailing surface of the bars. In this way, the smallest distance D between any two adjacent bars is being present at the leading surface of said two adjacent bars.

Such a design avoids the clogging problems of the prior art designs of sieves for stone pivking soil.

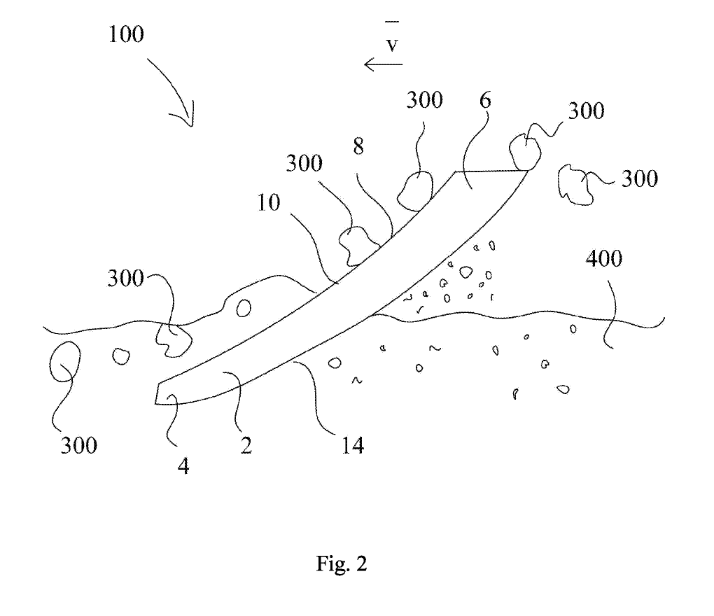

FIG. 2 is a plan view illustrating the working mode of the sieve 100 according to the first aspect of the present invention.

A sieve 100 comprising a number of individual bars 2,2′,2″,2″ arranged parallel to each other (only one bar is visible in the side view of FIG. 2) is moved through the soil 400 containing stones 300, sand, gravel and debris at velocity v in such a way that a lover end 4 of each bar 2,2′,2″,2′″ is submerged into the soil. As each bar is having a predetermined mutual distance d to any adjacent bar, the “mesh size” of the sieve can be determined.

In case the smallest distance between any two adjacent bars is being D no stone having a largest extension greater than D will be able to pass though the space between two adjacent bars 2,2′.

On the contrary any stone, sand, gravel or debris having an extension smaller than D will be able to pass through the space defined by two adjacent bars 2.2′.

In this way, the movement of the sieve 100 may be used for stone picking of stones in soil with the view to remove any stones having a size larger than a predetermined threshold size.

In FIG. 2 is shown that three stones 300 have been picked by the sieve 100 and is in the process of being moved to the upper part 6 of the bars and subsequently being moved backwards in order to exit the sieve upon which they will fall by the action of gravity. At this point the stones 300 may be picked up, e.g. by a conveyor belt and brought to a preliminary storage facility, such as a hopper in the vicinity of the sieve.

The movement of the stones up the leading surface of the sieve is brought about by the typical built-up of soil immediately in front of the sieve as it moves through the soil.

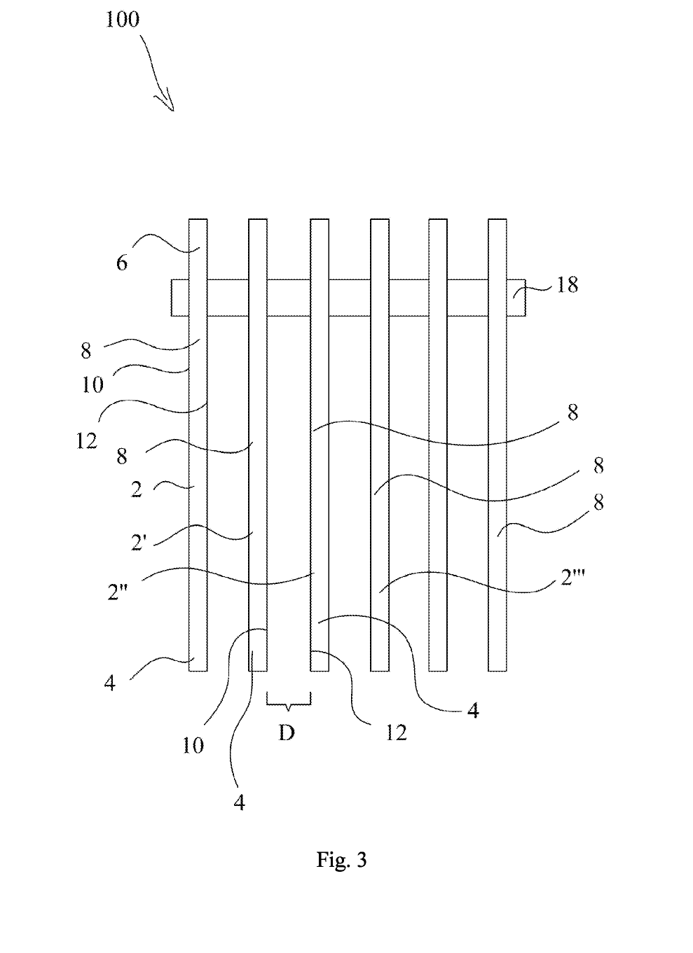

FIG. 3 is a top view of one embodiment of the sieve 100 according to the first aspect of the present invention.

FIG. 3 shows the sieve 100 comprising six bars 2,2′,2″,2″′. Each bar comprises a lower end 4 and an upper end 6. The leading surface 8 of each bar comprises a first edge 10 and a second edge 12.

The smallest distance D between any two adjacent bars 2′,2″ is present between a first edge 10 of the leading surface 4 of one bar 2′ and a second edge 12 of the leading surface of the adjacent bar 2″.

A bracket 18 is provided for reinforcing the sieve and for holding together the individual bars 2,2′,2″,2″′, making up the sieve.

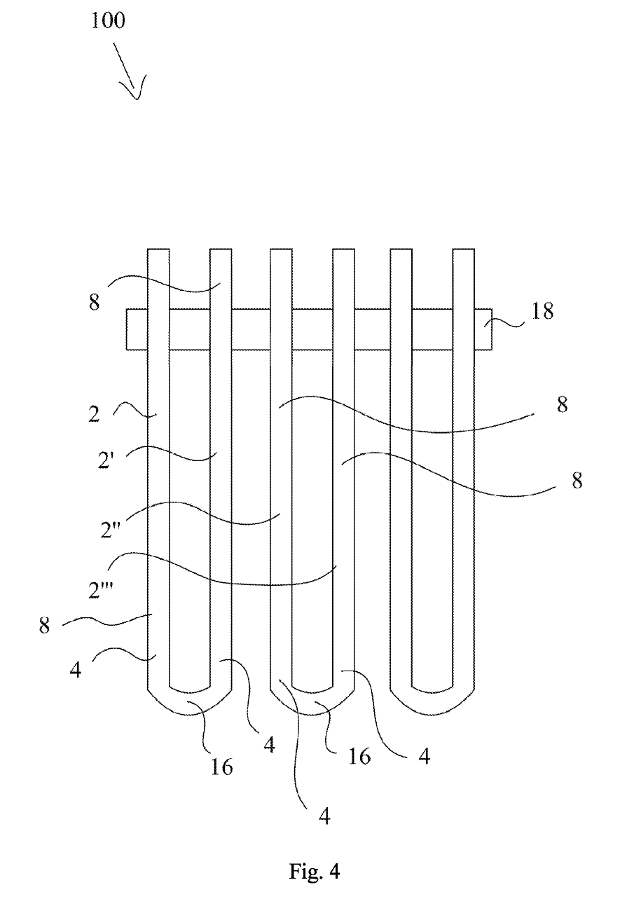

FIG. 4 shows an alternative embodiment og the embodiment shown in FIG. 3. FIG. 4 shows the sieve 100 comprising six bars 2,2′,2″,2″′. Each bar comprises a lower end 4 and an upper end 6.

FIG. 4 shows that in respect of two adjacent bars of the sieve, these two bars are being connected to each other by an end part 16.

In this way, the bars are being grouped in pairs in such a way that the lower end 4 of two adjacent bars 2,2′ and 2″, 2″′, respectively are being connected to each other so as to form a U-shape end of said two adjacent bars.

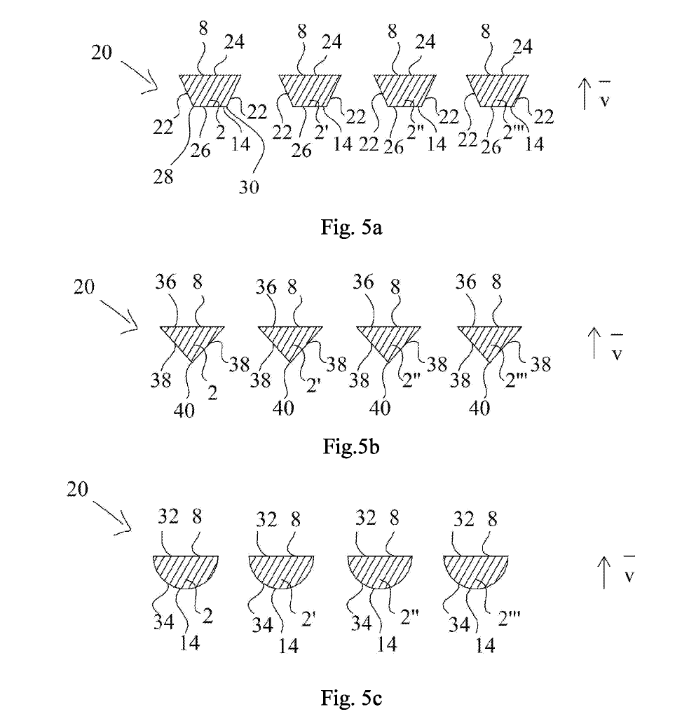

FIGS. 5a, 5b and 5c illustrate various geometries of preferred cross-sections 20 of the bars 2,2′,2″,2″′, of the sieve 100 according to the first aspect of the present invention.

FIG. 5a shows a cross-section of the bars 2,2′,2″,2′″ of a sieve comprising four bars. The bars 2,2′,2″,2″′, are each having a cross-section with the geometry of a an isosceles trapezoid. The trapezoid is having side legs 22 of equal length; the longest base 24 of the isosceles trapezoid is forming the leading surface 8 of the bar and the shortest base 26 of the isosceles trapezoid is forming the trailing surface 14 of the bar, thus extending between a first edge 28 and a second edge 30 of said trailing surface of that bar.

FIG. 5b shows a cross-section of the bars 2,2′,2″,2″′, of a sieve comprising four bars. The bars 2,2′,2″,2″′, are each having a cross-section with the geometry of a triangle, wherein one edge 36 of the triangle is forming the leading surface 8 of the bar, and wherein part of two edges 38 and one vertex 40 of the triangle is forming the trailing surface 14 of the bar.

FIG. 5c shows a cross-section of the bars 2,2′,2″,2″′, of a sieve comprising four bars. The bars 2,2′,2″,2″′, are each having a cross-section with the geometry of a semicircle, The diameter 32 of the semicircle is forming the leading surface 8 of the bar and wherein the curved perimeter 34 of the semicircle is forming the trailing surface 14 of the bar.

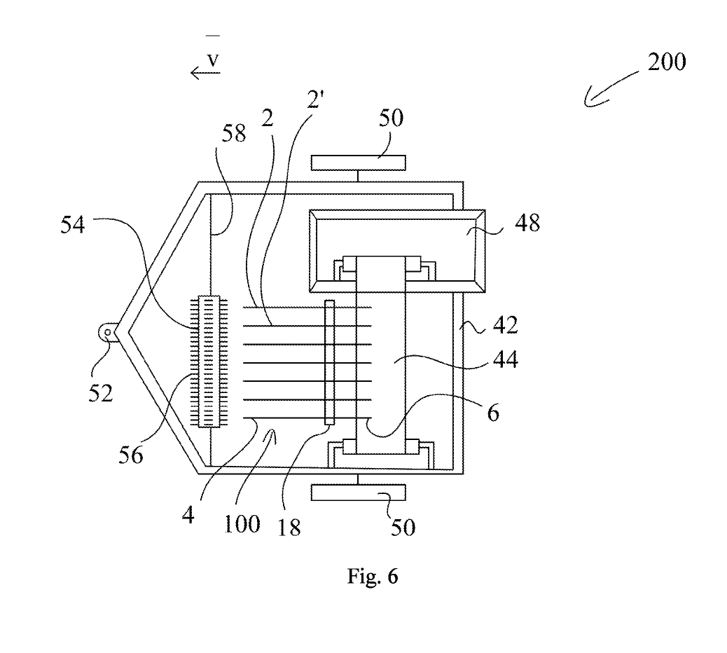

FIG. 6 is a schematic illustration showing a top view of a stone picking device 200 according to the second aspect of the present invention. The stone picking device 200 comprises a frame 42. The frame comprises a sieve 100 according to the first aspect of the present invention.

The sieve 100 is arranged on the frame 42 in such a way that a lower end 4 of the bars of the sieve is located relatively low and forward compared to the upper end 6 of the bars of the sieve.

Furthermore, the frame comprises stone conveying means 44 in the form of a conveyor belt for removing stones from an area located at an upper end 6 of said bars of said sieve.

The conveyor belt is arranged immediately below an upper end 6 of the bars 2,2′ of the sieve 100.

The stones conveyed by the conveying means 44, are conveyed to a hopper 48 for storing the stones removed by the stone conveying means.

The frame is suspended by wheels 50 and the frame comprises coupling means 52 for allowing the device to be towed by a tractor or the like.

Furthermore, FIG. 6 shows that the device 200 comprises soil loosening and/or stone lifting means 54 arranged in front of the sieve 100, relative to the intended direction of movement thereof.

The soil loosening and/or stone lifting means 54 comprises shears 56 arranged on an axle 58. The axle 58 is being configured to be able to rotate with the view to loosen soil and/or to lift from the soil, stones being present in the soil.

The device 200 is intended to be towed behind the tractor in the direction of movement defined by velocity vector v. The soil loosening and/or stone lifting means 54 arranged in front of the sieve 100 allows loosening of the soil and the stones. Subsequently, the stones being too large to fall and passing the space between two adjacent bars 2,2′ of the sieve 100 will be lifted by the bars of the sieve and end up on the conveyor belt 44, whereafter they will be transported to the hopper 48.

The stones, sand, gravel and debris having sizes enabling passage through the space between two adjacent bars 2,2′ of the sieve 100 will pass these.

Accordingly, the device 200 allows for easy and efficient stone picking from soil without the disadvantage of clogging the sieve of the device.

List of reference numerals

| | |
|---|---|
| 2,2′,2″,2′″ | Bar |
| 4 | Lower end of bar |
| 6 | Upper end of bar |
| 8 | Leading surface of bar |
| 10 | First edge of leading surface of bar |
| 12 | Second edge of leading surface of bar |
| 14 | Trailing surface of bar |
| 16 | End part connecting two adjacent bars at a lower end thereof |
| 18 | Bracket |
| 20 | Cross-section of bar |
| 22 | Side legs of trapezoid |
| 24 | Longest base of trapezoid |
| 26 | Shortest base of trapezoid |
| 28 | First edge of trailing surface of bar |
| 30 | Second edge of trailing surface of bar |
| 32 | Diameter of semicircle |
| 34 | Curved perimeter of semicircle |
| 36, 38 | Edges of triangle |
| 40 | Vertex of triangle |
| 42 | Frame of stone picking device |
| 44 | Stone conveying means |
| 46 | Depth adjustment means |
| 48 | Hopper |
| 50 | Wheels |
| 52 | Coupling means |
| 54 | Soil loosening and/or stone lifting means |
| 56 | Shear |
| 58 | Axle |
| d | Mutual distance between two adjacent bars |
| D | Smallest distance between two adjacent bars |
| L | Distance between first edge and second edge of leading |
| | surface of bar |
| v | Velocity vector of intended movement of sieve |
| 100 | Sieve |
| 200 | Stone picking device |
| 300 | Stone |
| 400 | Soil |

1. A sieve configured to pick stones from soil, wherein the sieve while in a use orientation comprises:
a plurality of bars, wherein each bar of the plurality of bars extends in a longitudinal direction between a lower end configured to be at least partly submerged in the soil and an upper end;
wherein each bar of the plurality of bars comprises a leading surface extending a distance from a first edge to a second edge of the leading surface of the bar;
wherein each bar of the plurality of bars comprises a trailing surface;
wherein the geometry of the plurality of bars and the sieve is configured such that a smallest distance between two neighboring bars of the plurality of bars is present between the leading surfaces of the two neighboring bars; and
wherein one or more sets of two adjacent bars of the plurality of bars, are grouped in one or more respective pairs such that the lower ends of the two adjacent bars within each pair are connected to each other.

2. The sieve according to claim 1, wherein at least one bar of the plurality of bars has a concave curvature in a lengthwise direction along the leading surface of the at least one bar.

3. The sieve according to claim 1, wherein at least one bar of the plurality of bars has a convex curvature in a lengthwise direction along the trailing surface of the at least one bar.

4. (canceled)

5. The sieve according to claim 1, wherein the lower ends of the two adjacent bars within each pair are connected to each other via an end part to form a U-shape end of the pair.

6. The sieve according to claim 1, wherein the plurality of bars is reinforced by connection to a bracket.

7. The sieve according to claim 6, wherein the bracket is mounted on the trailing surface of each bar of the plurality of bars.

8. The sieve according to claim 1, wherein the geometry of the plurality of bars and the sieve is configured such that the smallest distance between the two neighboring bars of the plurality of bars is only present at the leading surfaces of the two neighboring bars.

9. The sieve according to claim 1, wherein the plurality of bars are arranged in parallel on the sieve.

10-11. (canceled)

12. The sieve according to claim 1, wherein the geometry of the plurality of bars and the sieve is configured such that a mutual distance between the two neighboring bars of the plurality of bars varies along a length of the two neighboring bars.

13. The sieve according to claim 12, wherein the mutual distance varies along the length of the two neighboring bars so as to increase when going from the lower ends to the upper ends of the two neighboring bars, or so as to decrease when going from the lower ends to the upper ends of the two neighboring bars.

14. The sieve according to claim 1, wherein a cross-sectional shape of at least one bar of the plurality of bars is an isosceles trapezoid having side legs of equal length, the leading surface of the at least one bar forms a longer base of the isosceles trapezoid, and the trailing surface of the at least one bar forms a shorter base of the isosceles trapezoid.

15. The sieve according to claim 1, wherein a cross-sectional shape of at least one bar of the plurality of bars is a semicircle, wherein the leading surface of the at least one bar forms a diameter of the semicircle, and the trailing surface of the at least one bar forms a curved perimeter of the semicircle.

16. The sieve according to claim 1, wherein a cross-sectional shape of at least one bar of the plurality of bars is a triangle, wherein the leading surface of the at least one bar forms one edge of the triangle, and the trailing surface of the at least one bar forms part of two edges) and one vertex of the triangle.

17. The sieve according to claim 1, comprising an adjustment device configured to adjust a mutual distances between the two neighboring bars of the plurality of bars.

18. (canceled)

19. A stone picking device configured to pick and collect the stones from the soil, comprising:
a frame; and
the sieve according to claim 1;
wherein the frame comprises a stone conveying device configured to remove stones from an area located at the upper ends of the plurality of bars of the sieve.

20. The stone picking device according to claim 19, comprising a depth adjustment device configured to adjust a depth of submersion into the soil of the lower ends of the plurality of bars of the sieve.

21. The stone picking device according to claim 19, comprising a hopper configured to store the stones removed by the stone conveying device.

22-24. (canceled)

25. The stone picking device according to claim 19, comprising a soil loosening and/or stone lifting device arranged in front of the sieve relative to a direction of movement of the stone picking device.

26. The stone picking device according to claim 25, wherein the soil loosening and/or stone lifting device comprises shears arranged on an axle and configured to rotate to loosen the soil, to lift the stones from the soil, or a combination thereof.

27. (canceled)

28. A method for picking the stones from the soil, comprising:
providing the sieve according to claim 1;
arranging the sieve such that the lower end of each bar of the plurality of bars is at least partly submerged into the surface of the soil;
moving the sieve through the soil in a direction defined by the leading surface of each bar of the plurality of bars of the sieve; and
collecting and removing the stones having a size preventing them from passing between the two neighboring bars, while enabling soil material having smaller sizes to pass between the two neighboring bars.

29-30. (canceled)
